(19) United States
(12) Patent Application Publication
(10) Pub. No.: US 2026/0158691 A1
(43) Pub. Date: Jun. 11, 2026

(54) CUT-TO-SIZE MODULAR MOTORIZED WINDOW TREATMENT SYSTEM

(71) Applicant: KLONDIKE59, INC, Park City, UT (US)

(72) Inventors: Andrew E. EINAUDI, Scotts Valley, CA (US); Armand MATOSSIAN, Reno, NV (US); Arturo MEUNIOT, Wellington (NZ); Sujith Kuttanchery MELETHIL, Kerala (IN); Robert Bruce BROWN, Tiburon, CA (US); Michael M. BRYLAWSKI, Park City, UT (US)

(21) Appl. No.: 19/126,206

(22) PCT Filed: Oct. 31, 2023
(86) PCT No.: PCT/US2023/036515

§ 371 Date: Apr. 30, 2025

(30) Foreign Application Priority Data
Nov. 1, 2022 (IN) 202241062373

(51) Int. Cl. B26D 1/28; E06B 9/24; E06B 9/262; E06B 9/44; E06B 9/68; G01B 3/08; G01B 5/14

(52) U.S. Cl. CPC B26D 1/285; E06B 9/262; E06B 9/44; E06B 9/68; G01B 3/08; G01B 5/14; E06B 2009/2447; E06B 2009/2627

(57) ABSTRACT

A cut-to-size modular motorized window treatment with easy-to-install brackets, safe and precise cutting, and a modular/upgradeable platform is described herein. A collapsible measurement stick is locked in a first expanded position to extend between and hold first and second brackets in positions with respect to a window. The measurement stick indicates a measurement of the measurement stick in the expanded position. The brackets are mounted in their positions and the measurement stick is detached and then inserted in a roller cutter system that contains a roll of fabric. A cutter housing is slid along a rail system to a position indicated by the measurement stick. A cutting blade is rotated to penetrate the roll of fabric at the position. The roll of fabric is turned to cut the roll of fabric by the cutting blade. The resulting shorter length roll of fabric is removed from the roller cutter system.

### CROSS-REFERENCE TO RELATED APPLICATIONS

This application claims priority to India Provisional Application No. 202241062373, filed on Nov. 1, 2022, entitled “CUT-TO-SIZE MODULAR MOTORIZED WINDOW TREATMENT SYSTEM,” which is incorporated by reference herein in its entirety.

### BACKGROUND

Window shades are an effective way to provide privacy, block out light and heat or insulate from heat loss. Despite there being some standard sizes for windows, the windows boxes, window moldings and window openings that windows sit inside have a lot of variation in size and dimension. Therefore, the fabric to cover a window often requires a custom width to perform the job of adequately blocking the light or looking proper aesthetically—especially for blackout shades. Custom shade rods and fabric widths are either trimmed in factory, in-store at large cutting machines or at home with hacksaws and scissors which is prone to errors and/or injury.

### SUMMARY

Systems and methods are described herein for an easy-to-install, safe and precise cut-to-size modular window treatment system.

For instance, in an aspect, a window treatment system comprises a collapsible measurement stick locked in a first expanded position to extend between and hold first and second brackets in positions with respect to a window. The measurement stick indicates a measurement of a length of expansion of the measurement stick in the expanded position.

In a further aspect, the measurement stick comprises one or more of: a stick lock button configured to enable the measurement stick to be locked in a plurality of expanded positions including the first expanded position; a viewfinder that provides the measurement of the length of expansion of the measurement stick in any of the plurality of expanded positions; a stick removal/attach interface configured to enable attachment of the measurement stick between the first and second brackets, and removal of the measurement stick from between the first and second brackets, the viewfinder configured to maintain the measurement of the length of expansion of the measurement stick after the removal of the measurement stick; a stick level that provides a level indication corresponding to an orientation of the measurement stick; a code on a surface of the measurement stick that identifies a window treatment corresponding to the measurement stick. and/or at least one of a tension ratchet or a tension spring configured to maintain tension in the measurement stick.

In a further aspect, the first and second brackets are respectively positioned against opposing side jam extensions of a window, first and second locations on a window head casing, or first and second locations on a wall.

The window treatment system may further comprise a window treatment hung from the measurement stick.

In still a further aspect, the first bracket includes at least one preloaded screw interface configured to hold a corresponding screw in position to be screwed into a surface to secure the first bracket to the surface, and to enable a surface to be marked at a location prior to the corresponding screw being screwed into the surface.

In another aspect, a roller cutter system comprises: a cutter housing configured to receive a roll of fabric rolled around a fabric core; a cutting blade rotatably affixed to the cutter housing; a rail system having a length along which the cutter housing is movable to a plurality of cut positions; and a cutter lever rotatably affixed to the cutter housing and configured to rotate the cutting blade to penetrate the roll of fabric and cut the roll of fabric through the fabric core at a current cut position of the cutter housing along the length of the rail system.

In further aspects, the roller cutter system may further comprise one or more of: a cutter safety configured to receive a measurement stick, the cutter safety configured to lock the cutting blade when the measurement stick is not received and to unlock the cutting blade when the measurement stick is received; a spring configured to force the cutting blade to rotate into penetrating the roll of fabric; a cutter lever configured to receive manual force to rotate the cutting blade to penetrate the roll of fabric; a motor configured to rotate the roll of fabric; and/or a shipping box that contains the cutter housing, the roll of fabric, the cutting blade, the rail system, the cutter lever, and the motor, the roller cutter system operational to cut the roll of fabric inside the shipping box.

In aspects, the measurement stick is locked at a length of expansion used to define the cut position. The cutter safety is further configured to lock the cutting blade when the roll of fabric is not received by the cutter housing.

In another aspect, a method for a window treatment comprises: locking a collapsible measurement stick in a first expanded position to extend between and hold first and second brackets in positions with respect to a window, the measurement stick indicating a measurement of a length of expansion of the measurement stick in the expanded position; mounting the first and second brackets in the positions; detaching the measurement stick from the mounted first and second brackets; inserting the measurement stick in a roller cutter system that contains a roll of fabric; sliding a cutter housing along a rail system of the roller cutter system to a position matching the length of the locked measurement stick, when the locked measurement stick is engaged between the cutter housing and an endcap, the measurement stick unlocks the cutting blade; rotating a cutting blade of the cutter housing to penetrate the roll of fabric at the position; turning the roll of fabric to cut the roll of fabric by the cutting blade to a shorter length roll of fabric; and removing the shorter length roll of fabric from the roller cutter system.

The method may further comprise installing the shorter length roll of fabric between the first and second brackets as a first window shade for the window.

The method may still further comprise installing a roll of fabric for a cellular shade between the first and second brackets in parallel with the shorter length roll of fabric of the first window shade; and connecting a roller shade bottom hem bar of the first window shade and a cellular roller shade bar of the cellular shade to enable raising and lowering of the cellular shade with the first window shade by a motor of the first window shade.

In still another aspect, a method for refitting a fabric for a window treatment comprises: receiving an adjustable telescoping rod holding a first roll of fabric, the adjustable telescoping rod including first and second ends and a telescoping interface between the first and second ends, the first roll prevented from rotating relative to the adjustable telescoping rod by contact friction with the first and second ends and the telescoping interface; removing a ring-shaped fabric interface from the first end of the adjustable telescoping rod to unblock the first roll of fabric for removal at the first end; removing the first roll of fabric off from the adjustable telescoping rod at the first end; sliding a second roll of fabric onto the adjustable telescoping rod at the second end such that the second roll is prevented from rotating relative to the adjustable telescoping rod by contact friction with the first and second ends and the telescoping interface; and reattaching the ring-shaped fabric interface at the first end to block the secure the second roll of fabric on the adjustable telescoping rod.

The method may further comprise telescoping the adjustable telescoping rod to match a length of the second roll that is different from a length of the first roll.

The method may still further comprise cutting a length of the second roll on the adjustable telescoping rod to match a length of the adjustable telescoping rod.

Further features and advantages of the invention, as well as the structure and operation of various embodiments of the invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art(s) based on the teachings contained herein

### BRIEF DESCRIPTION OF THE DRAWINGS/FIGURES

The accompanying drawings, which are incorporated herein and form part of the specification, illustrate embodiments of the application and, together with the description, further serve to explain the principles of the embodiment and to enable a person skilled in the relevant art(s) to make and use the embodiments. Also included here are some definition of window specific terminology to assist in understanding the labeled figures and descriptions. A “head casing” is a type of trim that is used to frame the top of a door or window. It is typically shorter than the side casings and is installed horizontally above the door or window. The head casing is also known as a “header” or “lintel”. A “head jamb extension” is a strip of wood or board that is used to widen or increase the depth of the window jamb at the top of a window, whereas a “side jamb extension” is a strip of wood or board that is used to widen or increase the depth of the window jamb on the side of a window. Head and side jamb extensions are typically used when the window frame is not deep enough to fit the wall opening. The extension is attached to the interior side of the window jamb and provides the space necessary to fit the window frame to the window opening.

FIG. 1a depicts an interior window frame.

FIG. 1b depicts an interior window frame in detail with perspective and labels of pertinent facia for mounting a window system.

FIG. 2a depicts an “Inside Mount” using a measurement stick with built-in tension/ratchet, level, measurement viewfinder, lock and snap/removal interface and brackets with preloaded screw interface.

FIG. 2b depicts an “Inside Mount” with brackets with a preloaded screw interface.

FIG. 2c depicts an “Outside Mount” on a head casing with bracket template and brackets with preloaded screw interface.

FIG. 2d depicts an “Outside Mount” on a head casing with brackets with a preloaded screw interface.

FIG. 2e depicts an “Outside Mount” on a head casing using the measurement stick with built-in tension/ratchet, level, measurement viewfinder, lock and snap/removal interface and brackets with preloaded screw interface.

FIG. 2f depicts an “Outside Mount” on a wall with bracket template and brackets with preloaded screw interface.

FIG. 2g depicts an “Outside Mount” on a wall with brackets with a preloaded screw interface.

FIG. 2h depicts an “Outside Mount” on a wall using a measurement stick with built-in tension/ratchet, level, measurement viewfinder, lock and snap/removal interface and brackets with preloaded screw interface.

FIG. 2i depicts an adjustable measurement stick with built-in tension using ratchet or spring mechanisms, level, measurement viewfinder, lock and snap/removal interface.

FIG. 2j depicts bracket details showing stick removal/attach interface and preloaded screw interface.

FIG. 2k depicts a bracket template in detail for head casing (aka frame mount) and wall.

FIG. 3a depicts a manual force roller cutter with safety and measurement features built in including cutter rails and sled for precision cutting.

FIG. 3b depicts a spring force roller cutter with safety and measurement features built in including cutter rails and sled for precision cutting.

FIG. 3c depicts a cellular shade or blind cutter with safety and measurement features.

FIG. 3d depicts an adjustable width cutting system in a shipping box.

FIG. 3e depicts details of a rail system for cutter housing and motor end cap to ensure a stable/orthogonal cutting interface.

FIG. 3f depicts a manner in which the fabric must be wrapped to ensure a clean cut.

FIG. 3g depicts telescoping interfaces that ensure clean and safe cutting of the entire fabric roll.

FIG. 4a depicts telescoping rods with fabric attach points.

FIG. 4b depicts replaceable or swappable fabric interfaces.

FIG. 4c depicts a bracket extension interface and method for a light-bleed blackout blocker.

FIG. 4d depicts a bracket extension system for mounting two shades side by side.

FIG. 4e depicts multi-modal control and charging.

FIG. 4f depicts sensor pack and lighting add-ons for window treatments.

The features and advantages of the embodiments described herein will become more apparent from the detailed description set forth below when taken in conjunction with the drawings, in which like reference characters identify corresponding elements throughout. In the drawings, like reference numbers generally indicate identical, functionally similar, and/or structurally similar elements. The drawing in which an element first appears is indicated by the leftmost digit(s) in the corresponding reference number.

### DETAILED DESCRIPTION

### I. Introduction

The following detailed description discloses numerous example embodiments. The scope of the present patent application is not limited to the disclosed embodiments but also encompasses combinations of the disclosed embodiments, as well as modifications to the disclosed embodiments.

Terms and phrases used in this document, and variations thereof, unless otherwise expressly stated, should be construed as open ended as opposed to limiting. As examples of the foregoing: the term “including” should be read as meaning “including, without limitation” or the like; the term “example” is used to provide exemplary instances of the item in discussion, not an exhaustive or limiting list thereof; the terms “a” or “an” should be read as meaning “at least one,” “one or more” or the like; and adjectives such as “conventional,” “traditional,” “normal,” “standard,” “known” and terms of similar meaning should not be construed as limiting the item described to a given time period or to an item available as of a given time, but instead should be read to encompass conventional, traditional, normal, or standard technologies that may be available or known now or at any time in the future.

References in the specification to “one embodiment,” “an embodiment,” “an example embodiment,” or the like, indicate that the embodiment described may include a particular feature, structure, or characteristic, but every embodiment may not necessarily include the particular feature, structure, or characteristic. Moreover, such phrases are not necessarily referring to the same embodiment. Furthermore, when a particular feature, structure, or characteristic is described in connection with an embodiment, it is submitted that it is within the knowledge of persons skilled in the relevant art(s) to implement such feature, structure, or characteristic in connection with other embodiments whether or not explicitly described.

In the discussion, unless otherwise stated, adjectives such as “substantially” and “about” modifying a condition or relationship characteristic of a feature or features of an embodiment of the disclosure, are understood to mean that the condition or characteristic is defined to within tolerances that are acceptable for operation of the embodiment for an application for which it is intended.

Furthermore, it should be understood that spatial descriptions (e.g., “above,” “below,” “up,” “left,” “right,” “down,” “top,” “bottom,” “vertical,” “horizontal,” etc.) used herein are for purposes of illustration only, and that practical implementations of the structures and drawings described herein can be spatially arranged in any orientation or manner. Additionally, the drawings may not be provided to scale, and orientations or organization of elements of the drawings may vary in embodiments.

As used herein, the term “interior window frame” refers to the side of a window frame interior to a dwelling (e.g., a room, a home, an office, a retail space, etc.) for a window frame affixed in a wall of the dwelling. The term “inside mount” or “inside mount window covering” refers to a window covering mounted within a window frame. The term “outside mount” or “outside mount window covering” refers to a window covering mounted to or outside the window frame, such as being mounted to the wall above the window frame or the head casing of the window frame.

Numerous exemplary embodiments are described as follows. It is noted that any section/subsection headings provided herein are not intended to be limiting. Embodiments are described throughout this document, and any type of embodiment may be included under any section/subsection. Furthermore, embodiments disclosed in any section/subsection may be combined with any other embodiments described in the same section/subsection and/or a different section/subsection in any manner.

### II. Example Cut-to-Size Modular Motorized Window Treatment System

As noted in the Background Section above, window shades are an effective way to provide privacy, block out light and heat or insulate from heat loss. Despite there being some standard sizes for windows, the windows boxes, window moldings and window openings that windows sit inside have a lot of variation in size and dimension. Therefore, the fabric to cover a window often requires a custom width to perform the job of adequately blocking the light or looking proper aesthetically - especially for blackout shades. Custom shade rods and fabric widths are either trimmed in factory, in-store at large cutting machines or at home with hacksaws and scissors which is prone to errors and/or injury.

Easy-to-install, safe and precise cut-to-size modular motorized window treatment systems and methods are described herein that address various shortcomings of existing solutions. Some benefits of the disclosed embodiments are outlined immediately below.

Easy to Install. The basis of any window treatment system are the brackets used to hang the window treatment. The systems described herein make use of the following user-friendly methods designed to overcome many of the difficulties of traditional bracket systems: (1) integrated measurement system; (2) integrated leveling apparatus; (3) integrated tension/telescoping bar (temporary, semi-permanent, permanent) for inside mounted treatments; (4) preloaded screw interface (no need to hold screws while mounting); and (5) bracket placement template (for perfect even offsetting, insetting from window jamb for outside mounted treatments).

Safe and Precise Cut-to-Size. Common cut-to-size window treatments use expensive, large format and complex manufacturing equipment in factories, job shops, or at the hardware store. At-home cut-to-size methods often rely on dangerous methods such as the use of kitchen knives, handsaws or circular saws. Another common at-home approach is to use scissors or rotary blade cutter, but using this approach makes it very difficult to achieve a precise straight cut for long run fabrics to cover a wall glass pane.

The systems described herein use a safety housing adapted to utilize standard low-cost, disposable blades that are designed for safe and precise cutting with a built-in measurement safety latch to ensure cuts are safe and only to measurement. These systems can provide the quality and safety of factory-built shades with the flexibility, standardization, and low-cost of at-home methods. Exemplary systems include: (1) manual force roller cutter (also known as fabric slitter) with integrated safety and measurement feature; (2) spring force (torsion, extension, constant force, clock spring) roller cutter (also known as fabric slitter) with integrated safety and measurement feature; (3) cellular shade or blind cutter with integrated safety and measurement feature; (4) adjustable width cutting system in shipping box or tube; (5) rails to ensure orthogonal cutting interface in shipping box; (6) fabric wrapping for clean cuts; and (7) telescoping rod interface to ensure clean cutting completely through fabric roll.

Modular. Most window treatments are stand-alone systems that offer limited or no accessorizing or upgradeability/replaceability after install. Common accessories are limited to things like valances and brackets caps. There is no system today that allows for easy replacement of fabric, add-on of secondary window coverings, sensor packs, lighting options, and multi-modal control and charging by the end user.

The system described herein is a modular/upgradeable platform that will continue to deliver value for decades. The system may comprise and/or support: (1) telescoping rod interfaces for rolled fabric (cut-to-size or stretchable fabrics); (2) replaceable or swappable fabrics; (3) bracket extension interface for light-bleed blackout blocker; (4) easy and precise bracket width extension for hanging multiple shades; (5) multi-modal control via smart phone, remote, light switch, pull chain (single & grouped control), cloud automation, pull on fabric or bottom hem; (6) multi-modal charging via pull chain, solar, battery pack, mobile phone or other charging device or means; (7) sensor pack upgrades integrating sensors into shade with shared battery power; and (8) lighting solutions integrated into shade with shared or independent battery power.

The Power of the System. Solar shades that are dynamically controlled via motors with home automation or the cloud are proven to provide significant improvements in visual and thermal comfort whilst also saving energy up to 40%.

Dynamic solar shades, even when paired with simple, low-performance windows (which comprise over 85% of all installed windows), create a powerful dynamic system that rivals expensive triple pane coated glass or electrofilms in terms of thermal performance. However, the adoption of automated solar shades has been greatly impeded by an industry that requires customization at the installer, and a fabrication level which has great inefficiencies in terms of cost, decision making, lead times, etc.

A significant benefit of the system described herein is high-volume, low-cost manufacturing of quality automated shades that can be easily installed by an end user, which will unlock dynamic shading as a scaled, mainstream technology for window treatments and home energy efficiency.

Example embodiments of an easy-to-install, safe and precise cut-to-size, modular motorized window treatment system will now be described in reference to the accompanying figures.

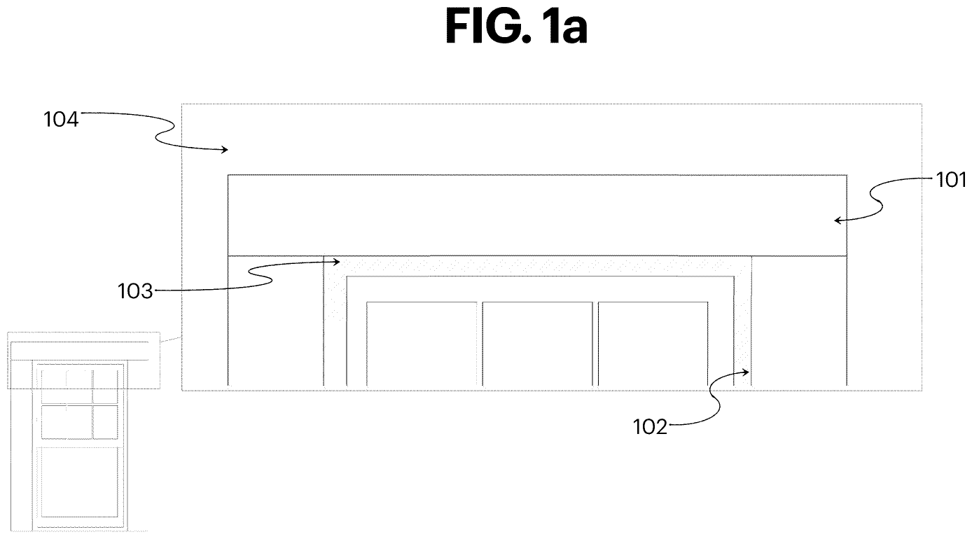

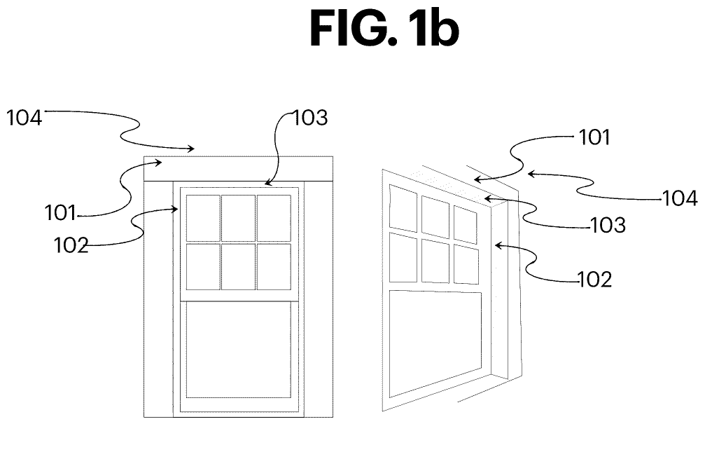

In particular, FIG. 1a depicts an interior window frame comprising a head casing 101 and a side jamb extension 102.

FIG. 1b depicts an interior window frame in detail with perspective and labels of pertinent facia for mounting a window system. FIG. 1b includes head casing 101 and side jamb extension 102 of FIG. 1a and also shows head jamb extension 103 and wall 104.

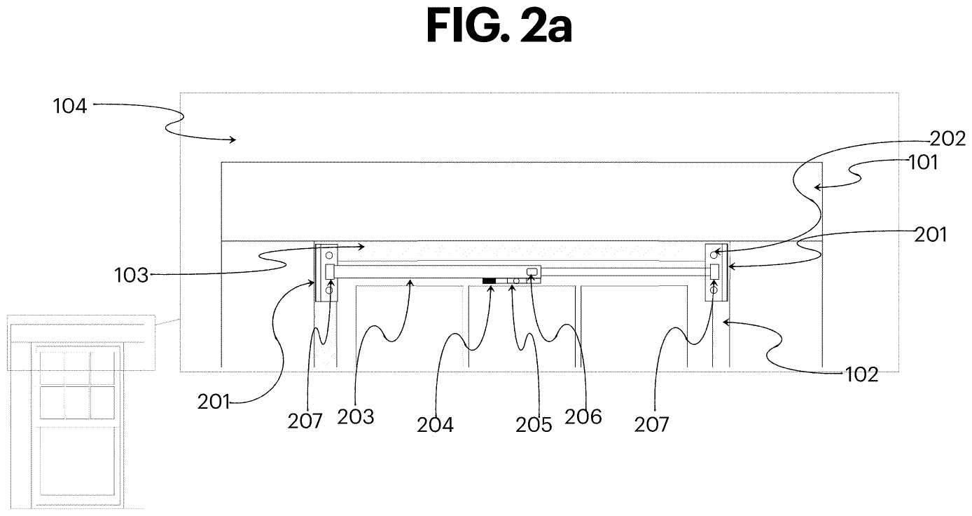

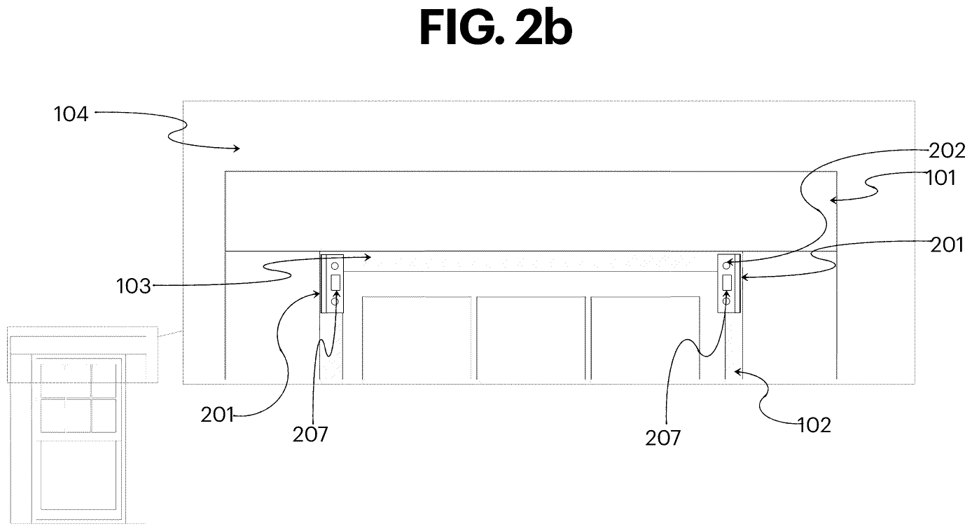

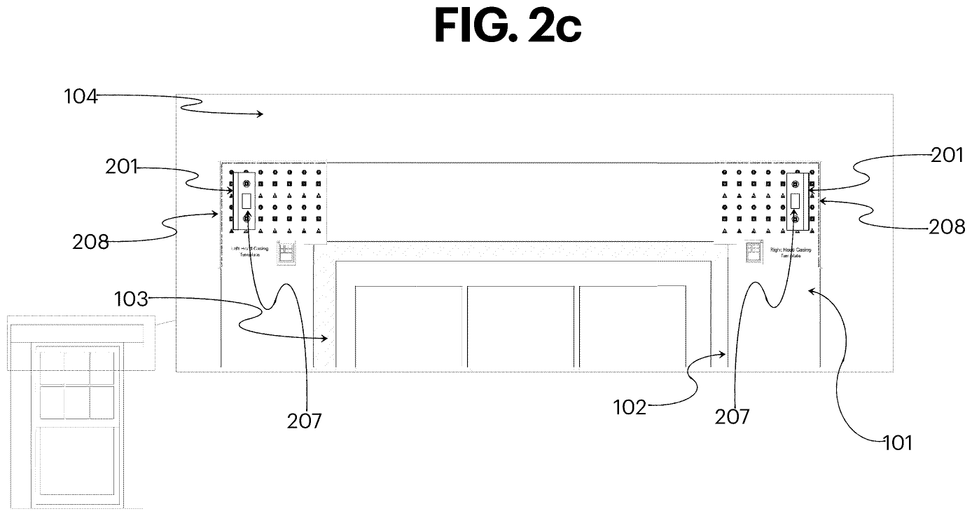

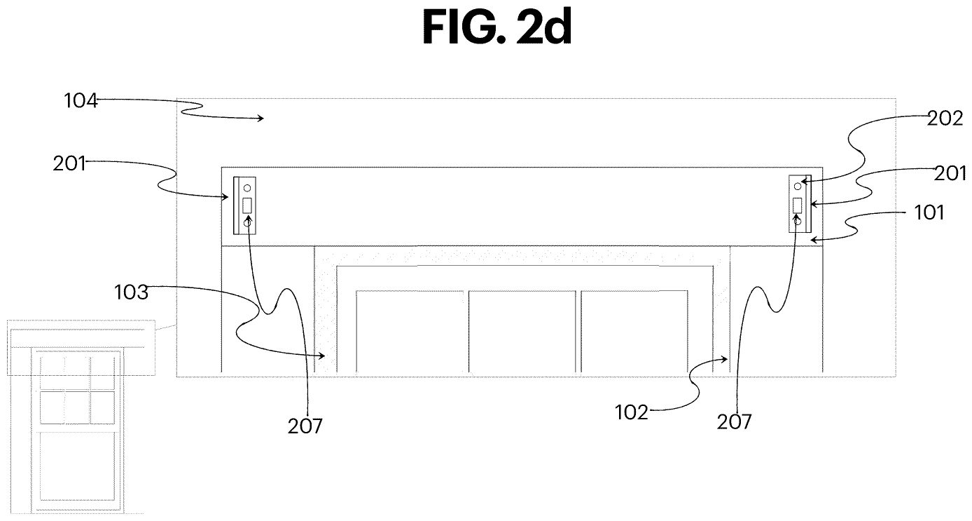

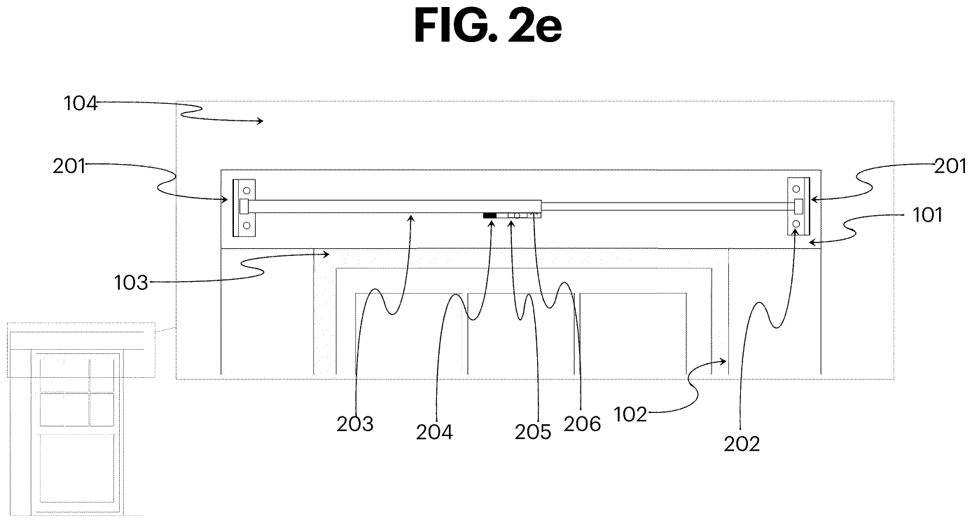

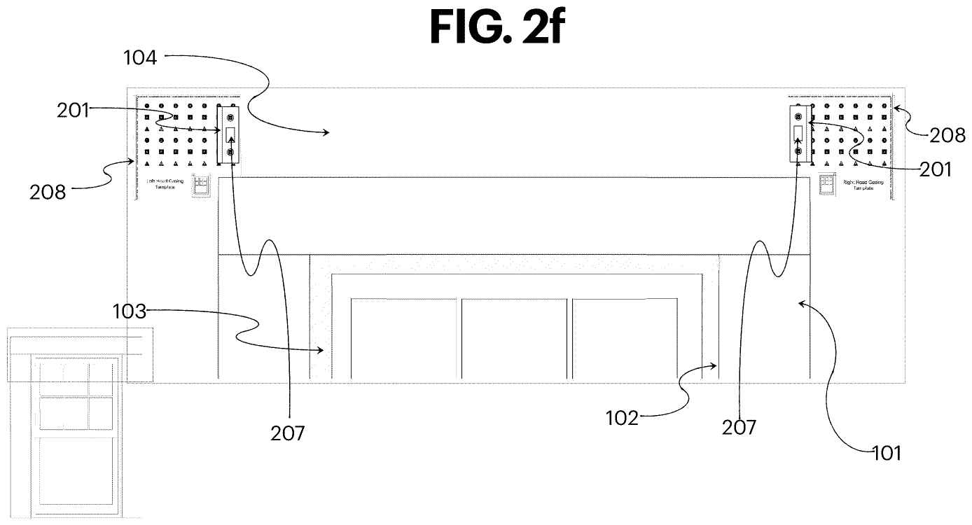

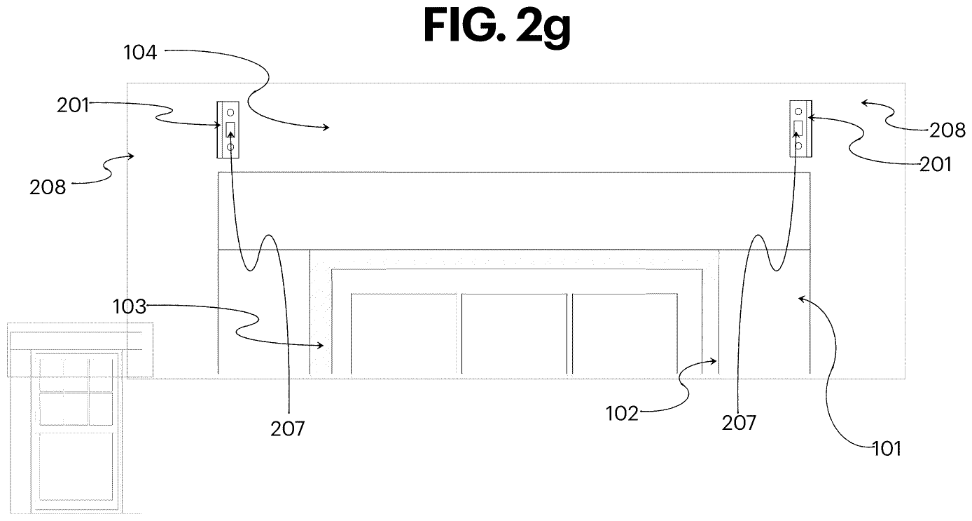

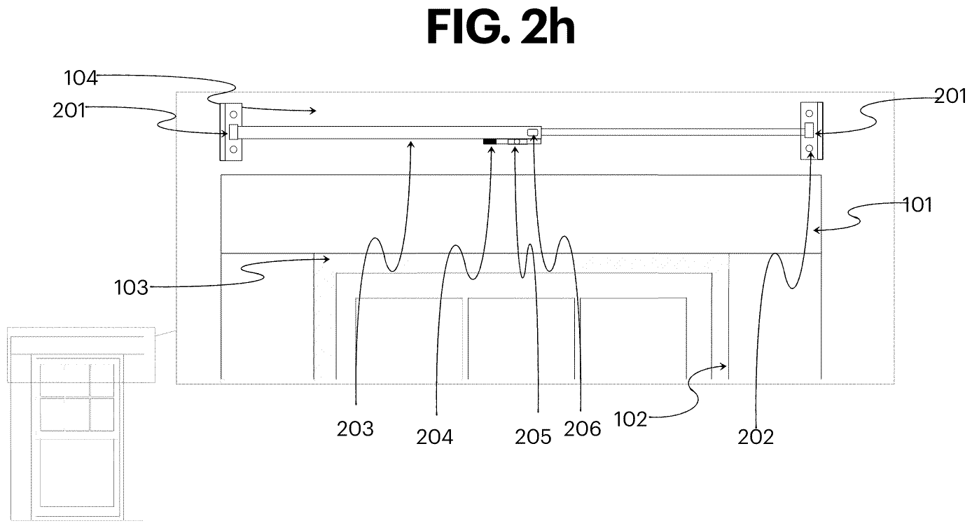

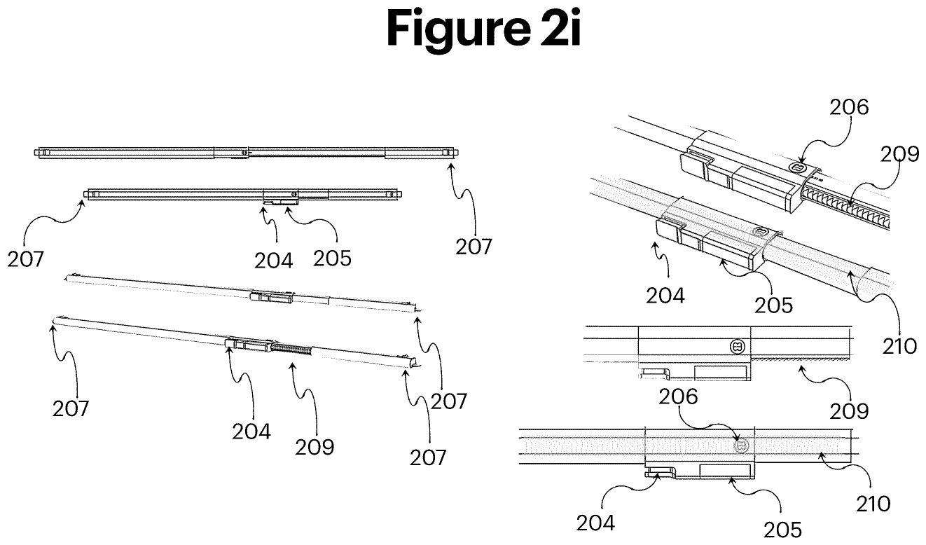

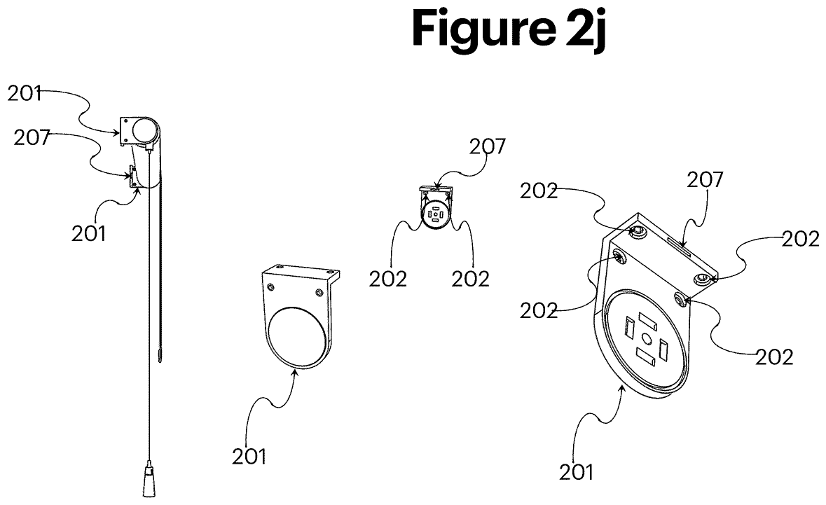

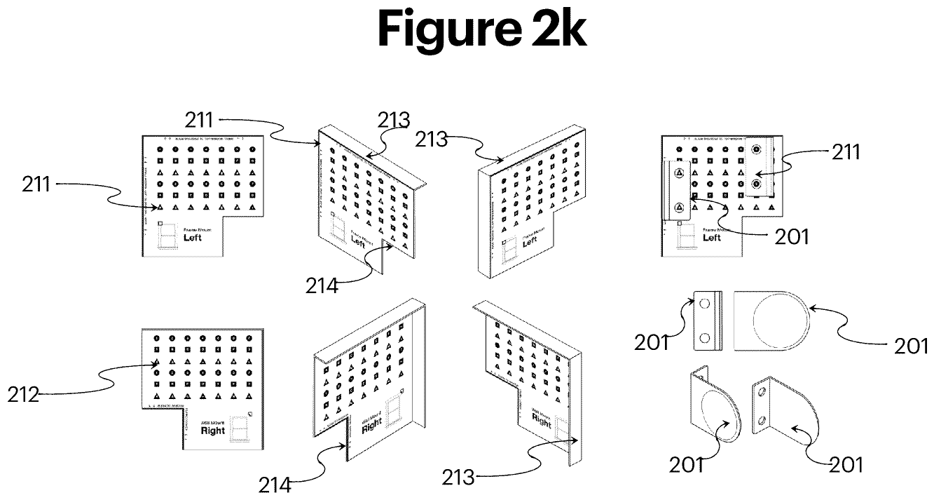

FIG. 2a illustrates an inside mount installation using a measurement stick 203 placed between the two window side jamb extensions 102. The measurement stick 203 uses a ratcheting and/or tensioning system to hold the brackets 201 in place hands free for easy installation. For instance, measurement stick 203 may be telescoping, such as by having multiple segments that can be expanded to increase length or contracted into one another. The user can then manually adjust each bracket 201 up/down as needed to achieve the ideal hanging position for the window treatment. A stick level 205 is included to provide level information. Although, the user may choose to not level and keep the brackets mounted “plumb” or aligned to the window casing which may not be level. The user can adjust the measurement stick 203 by pressing the stick lock 204 button to expand or collapse the measurement stick 203. In another example of stick lock 204, measurement stick 203 may be expanded or contracted to a desired length, then twisted to lock (e.g., twisting measurement stick 203 may squeeze a rubber screw inside that locks measurement stick 203). The measurement stick 203 also indicates its measurement as seen through the measurement viewfinder 206.

Because the measurement stick 203 provides a tensioning system, the user may choose not to use screws and instead use the force of the measurement stick tension to hold the brackets 201 and eventual window covering in place without screws. This means no holes, no marks and is a great solution for renters or people who are adverse to drilling holes in their home.

If the user chooses to use screws, the brackets have a feature for a preloaded screw interface 202. This way the user can place the screws into the brackets to be held in place hands-free. This is especially useful to prevent dropping screws and/or avoid poorly aligned screwing at the bracket interface. The preloading can also be useful in cases where the user wants to mark a surface (e.g., wall) prior to drilling a hole. The preloaded screws can protrude from the bracket slightly enough to leave marks if needed.

The measurement stick 203 can easily be detached from the mounted brackets 201 using the stick removal/attach interface 207, which consists of a latch, button, magnet or other attachment interface. The stick lock 204 will maintain the measurement and measurement viewfinder 206 for when the window treatment needs to be cut to fit the window.

FIG. 2b illustrates the brackets 201 mounted for an inside mount on window jamb extensions 103. In this case, the user has screwed in the brackets 201 and removed the measurement stick 203.

FIG. 2c illustrates an outside mount installation using bracket templates 208 to achieve perfect offsetting/insetting of the brackets 201 on the window head casing 101. Each bracket template 208 provides a variety of alignment features using numbers, colors, shapes to allow a user to align left and right brackets 201 precisely. The bracket template 208 also has a built-in ledge to allow it to rest on a window casing. The user can use the preloaded screw interface 202 to easily mark the wall or window surface for drilling if needed.

FIG. 2d illustrates the outside mounted brackets 201 on the window head casing 101. Each bracket 201 features a preloaded screw interface 202. This is especially useful to prevent dropping screws and/or poorly aligned screwing at the bracket interface. The preloading can also be useful in cases where the user wants to mark a surface (e.g., wall) prior to drilling a hole.

FIG. 2e illustrates an outside mount installation with the measurement stick 203 on the window head casing 101. If the screws have not been fully tightened, the user can then manually adjust each bracket 201 up/down as needed to achieve the ideal hanging position for the window treatment. A stick level 205 is included to provide level information. Although, the user may choose to not level and keep the brackets mounted “plumb” or aligned to the window casing which may not be level. The user can adjust the measurement stick 203 by pressing the stick lock 204 button to expand or collapse the measurement stick 203. The measurement stick 203 also indicates its measurement as seen through the stick measurement viewfinder 206.

The measurement stick 203 can easily be detached from the mounted brackets 201 using the stick removal/attach interface 207, which consists of a latch, button, magnet or other attachment interface. The stick lock 204 will maintain the measurement and measurement viewfinder 206 for when the window treatment needs to be cut to fit the window.

FIG. 2f illustrates an outside mount installation using bracket templates 208 to achieve perfect offsetting/insetting of the brackets 201 on a wall 104. Each bracket template 208 provides a variety of alignment features using numbers, colors, shapes to allow a user to align left and right brackets precisely. The bracket template 208 also has a built-in ledge to allow it to rest on a window head casing 101. The user can use the preloaded screw interface 202 to easily mark the wall or window surface for drilling if needed.

FIG. 2g illustrates the outside mounted brackets 201 on a wall 104. Each bracket 201 features a preloaded screw interface 202. This is especially useful to prevent dropping screws and/or poorly aligned screwing at the bracket interface. The preloading can also be useful in cases where the user wants to mark a surface (e.g., wall) prior to drilling a hole.

FIG. 2h illustrates an outside mount installation with a measurement stick 203 on a wall 104. If the screws have not been fully tightened, the user can then manually adjust each bracket 201 up/down as needed to achieve the ideal hanging position for the window treatment. A stick level 205 is included to provide level information. Although, the user may choose to not level and keep the brackets mounted “plumb” or aligned to the window casing which may not be level. The user can adjust the measurement stick 203 by pressing the stick lock 204 button to expand or collapse the measurement stick 203. The measurement stick 203 also indicates its measurement as seen through the measurement viewfinder 206.

The measurement stick 203 can easily be detached from the mounted brackets 201 using the stick removal/attach interface 207, which consists of a latch, button, magnet or other attachment interface. The stick lock 204 will maintain the measurement and measurement viewfinder 206 for when the window treatment needs to be cut to fit the window.

FIG. 2i illustrates the details of the measurement stick 203. The measurement stick 203 uses a tension ratchet 209 and/or tension spring 210 system to maintain tension for temporary mounting of brackets 201 or semi-permanent/permanent hanging of window treatment without screws. The measurement stick 203 also features an integrated stick level 205 and stick lock 204 mechanism for retaining precise measurement when used with window treatment cutting systems. The measurement stick can be detached from the brackets 201 after mounting. In some cases, the measurement stick 203 is used as the hem/weight bar for the window treatment.

The measurement stick 203 can remain in place for permanent hanging of a window treatment in screwless configuration for use cases such as renters or users who do not want to screw into their walls or windows.

A QR code can be placed on the measurement stick 203 to uniquely identify the window treatment the measurement stick belongs to for setup, support or purchase or for remote control scenarios.

FIG. 2j illustrates the bracket 201 to show the measurement stick attach/removal interface 207 for removing and attaching the measurement stick 203, as well as the preloaded screw interface 202. The preloaded screw interface 202 is especially useful to prevent dropping screws and/or to avoid poorly aligned screwing at the bracket interface. The preloading can also be useful in cases where the user wants to mark a surface (e.g., wall) prior to drilling a hole. Brackets 201 are designed to be symmetrical for left/right top/bottom mounting configurations. The four slots arranged in a circle in bracket 201 are hook slots that may be present for the motor to hang (e.g., by two hooks of the motor).

FIG. 2k illustrates the bracket template 208 details. The bracket template 208 can be made out of plastic or cardboard or metal and provides alignment features to the edge of head casing of the window appropriate for both wall mount insetting/offsetting and head case insetting/offsetting. The template casing alignment feature 213 is designed to rest on the window head casing 101 and align to it by hanging over the edge of a head casing 101. The template edge alignment feature 214 is designed to rest on the wall 104 and align to the corner of the window head casing. The bracket template 208 uses a variety of numbers, letters, shapes and colors to make bracket alignment easy. The user just needs to match the number, letters, shapes and/or colors for left and right to have a perfect mounting location. The user may use a bracket or a pencil to mark their holes.

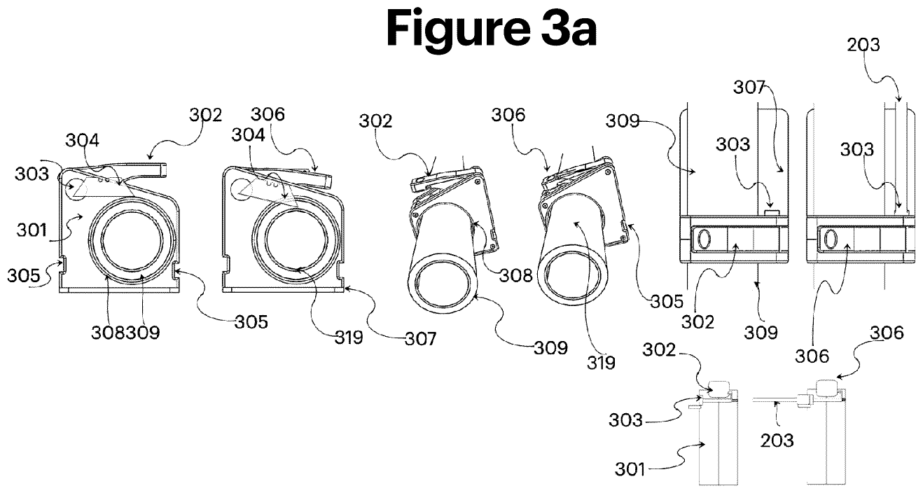

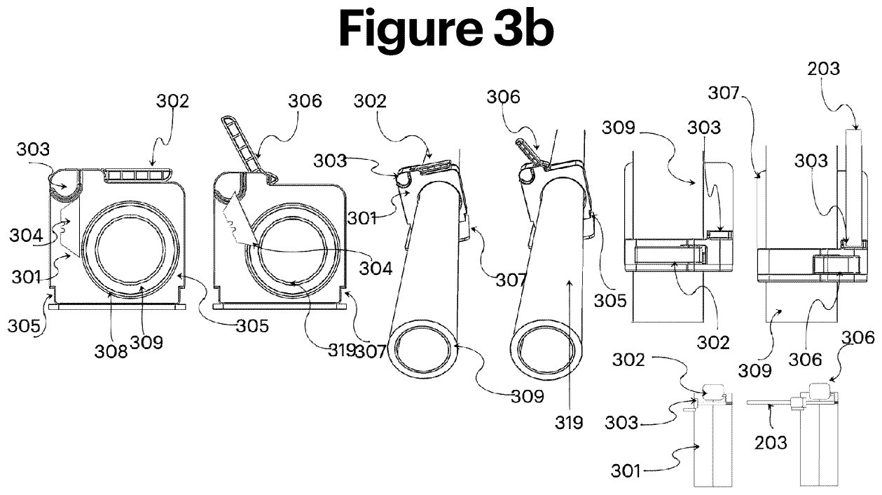

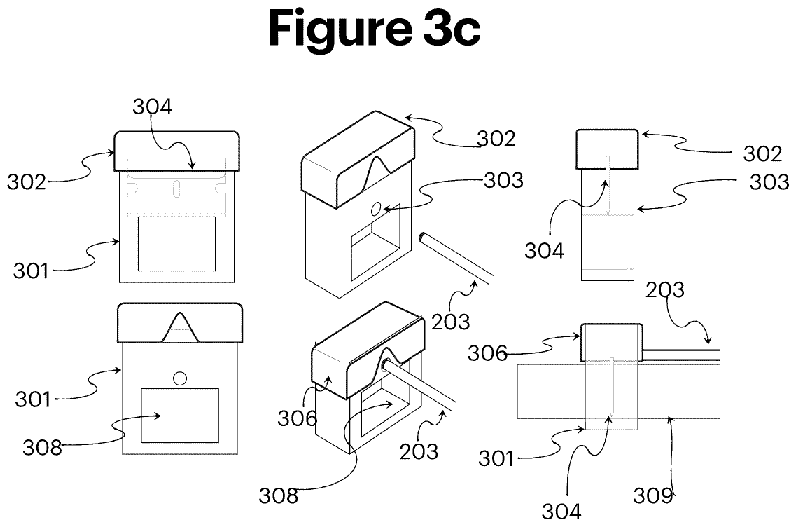

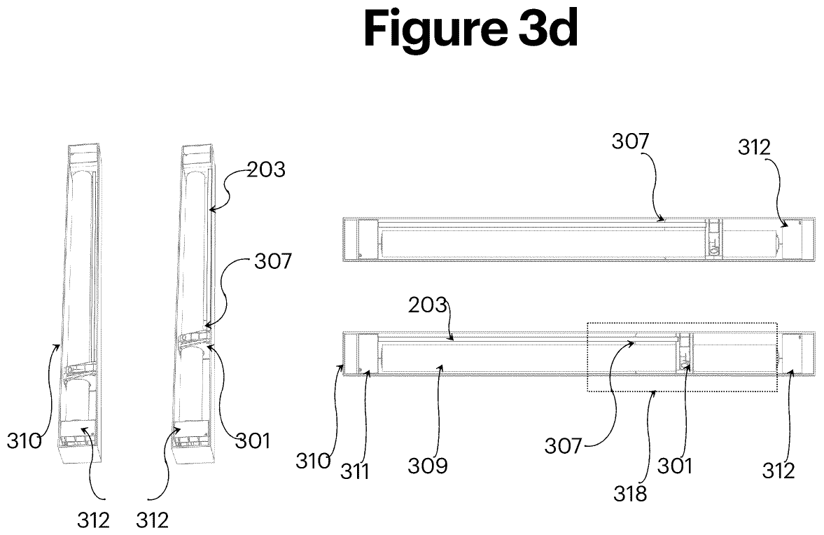

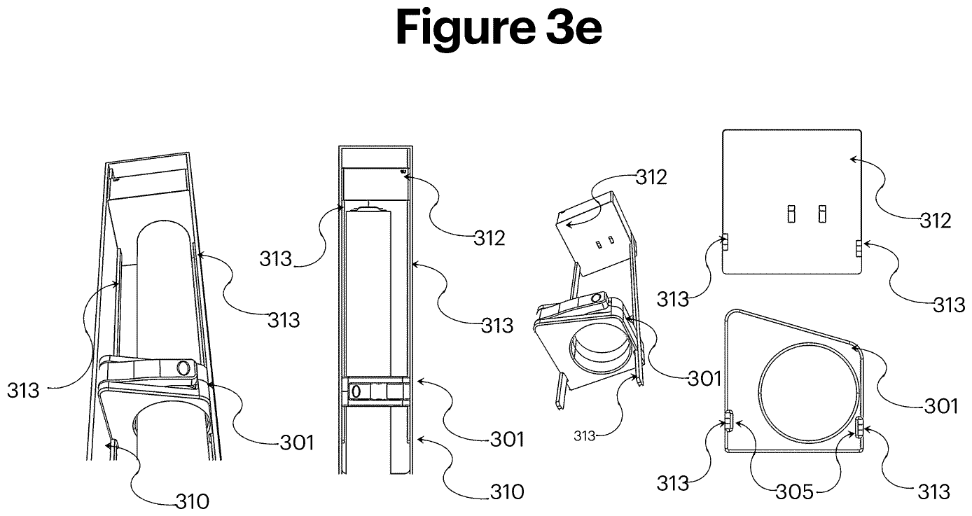

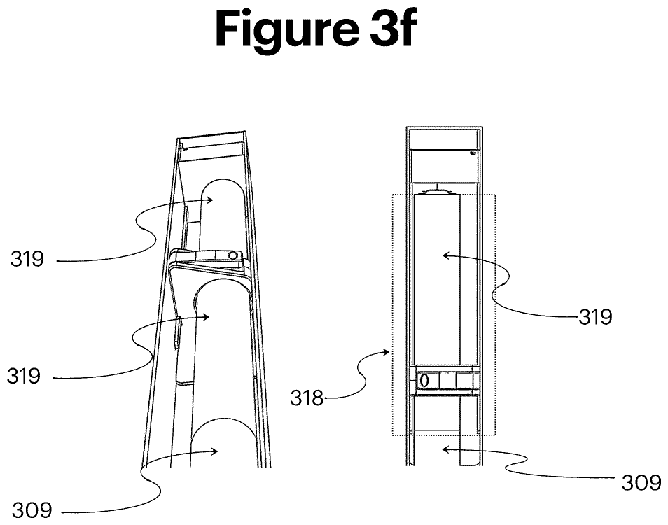

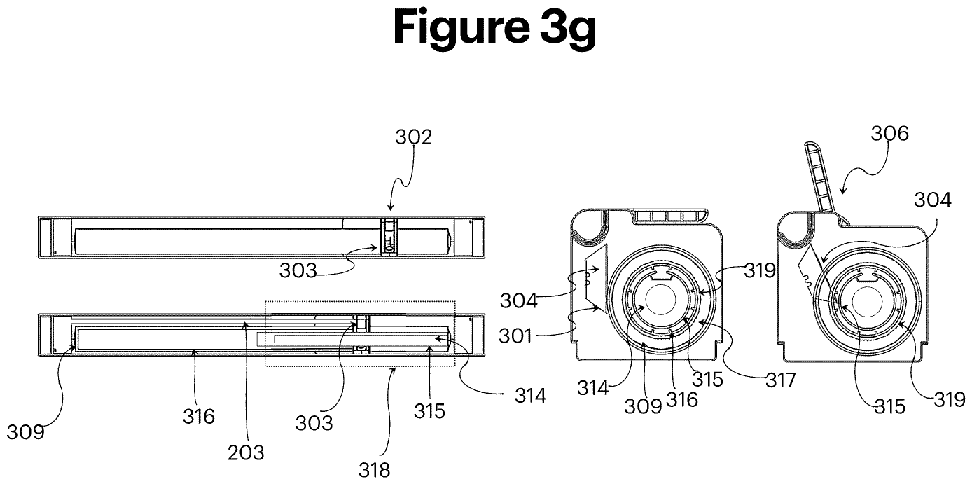

FIG. 3a illustrates a manual force roller cutter system (also known as fabric slitter) with cutter safety 303 which keeps the cutter lever locked 302 until the measurement stick 203 is inserted and/or a roll of fabric 309. The manual force cutter can use low cost off-the-shelf cutting blades 304 such as utility, circular, razor, exacto or box cutter type. Serrated blades perform best. The blade 304 is held in place by a swing arm that can be locked by the cutter safety 303 to prevent accidental use. The measurement stick 203 can be used in conjunction with the cutter safety 303 to ensure that cutting only happens with a measurement stick 203 in place. The cutter safety 303 can also be used in conjunction with the cutter tunnel 308 lock out mechanism so that the blade 304 can only be actuated when fabric is inside the cutter tunnel 308. The rotation of fabric 309 against the cutter blade 304 requires a good amount of radial force. The use of cutter rail interface 305 and cutter sled 307 keeps the cutter housing 301 from moving while the fabric 309 is spinning. The cutter rail interface 305 also holds the motor end cap in place. This is critical to maintain a perfect cut.

With the manual force roller cutter, when the cut is done, the user simply stops applying force to the unlocked cutter lever 306. With the blade 303 retracted, the user can slide out the cut fabric roll. With the measurement stick 203 removed, the cutter safety 303 will ensure the blade remains locked and cutter housing 301 is safe to handle.

The cutter safety 303 can use simple latch or cam and plunger mechanisms. Locking pins with interlocks can also be used. The solution shown in illustration shows a simple spring and plunger and latch design.

FIG. 3b illustrates a spring force roller cutter system (also known as fabric slitter) with cutter safety 303 which keeps the cutter lever locked 302 until the measurement stick 203 is inserted and/or a roll of fabric 309. The manual force cutter can use low cost off-the-shelf cutting blades 304 such as utility, circular, razor, exacto or box cutter type. Serrated blades perform best. The blade 304 is held in place by a swing arm that can be locked by the cutter safety 303 to prevent accidental use. The measurement stick 203 can be used in conjunction with the cutter safety 303 to ensure that cutting only happens with a measurement stick 203 in place. The cutter safety 303 can also be used in conjunction with the cutter tunnel 308 lock out mechanism so that the blade 304 can only be actuated when fabric is inside the cutter tunnel 308. The rotation of fabric 309 against the cutter blade 304 requires a good amount of radial force. The use of cutter rail interface 305 and cutter sled 307 keeps the cutter housing 301 from moving while the fabric 309 is spinning. For instance, cutter sled 307 may be configured to lengthen the area of cutter housing 301 that is in contact with cutter rail interface 305 such that less wiggle is available. The cutter rail interface 305 also holds the motor end cap in place. This is critical to maintain a perfect cut. With the measurement stick 203 removed, the cutter safety 303 will ensure the blade remains locked and cutter housing 301 is safe to handle.

The cutter safety 303 can use simple latch or cam and plunger mechanisms. Locking pins with interlocks can also be used. The solution shown in illustration shows a simple spring and plunger and latch design.

The spring force for the roller cutter is sufficient to cut through all the fabric and the fabric core. The spring force can be achieved using torsion, constant force, extension or clock spring depending on cost and size constraints. Once the cut is done, the cutter lever can be returned to the locking position and fabric 309 removed.

FIG. 3c illustrates a cellular or blind cutter with cutter safety 303 which keeps the cutter lever locked 302 until the measurement stick 203 is inserted and/or a cellular or blind fabric 309 or material. The cutter of FIG. 3c is configured for an alternative type of window covering, such as a cellular or horizontal blind, where the material is cut with a guillotine type cutter, as opposed to a fabric roll which applies a fabric slitting approach. This cutter can use low cost off-the-shelf cutting blades 304 such as utility, circular, razor, exacto or box cutter type. Serrated blades perform best. Guillotine cutters perform well against the materials used in conventional cellular and blind window systems. Manual or spring force can be used to achieve the cut. The blade 304 is held in place with a cutter safety 303 to prevent accidental use. The measurement stick 203 can be used in conjunction with the cutter safety 303 to ensure that cutting only happens with a measurement stick in place. The cutter safety 303 can also be used in conjunction with the cutter tunnel lock so that the blade 304 can only be actuated when fabric is inside the cutter tunnel. With the measurement stick 203 removed, the cutter safety 303 will ensure the blade remains locked and cutter housing 301 is safe to handle.

The cutter safety 303 mechanisms can use simple latch or cam and plunger mechanisms. Locking pins with interlocks can also be used.

FIG. 3d illustrates an adjustable width cutting system in a shipping box 310. The cutting system of FIG. 3d may be used inside or outside of shipping box 310. The cutter housing 301 can be adjusted left/right moving on a rail 313 system. The rail 313 keeps the cutter housing 301 and motor end cap 312 from moving radially while the fabric 309 is being cut. The cutter sled 307 keeps the cutter housing 301 co-axial during the cutting.

A shipping tube can also be used to allow the cutter housing 301 to be adjusted relative to the fabric.

FIG. 3e illustrates the cutter rail interface 305 and cutter sled 307 system utilized to secure the cutter housing 301 and rotational motor relative to the fabric 309 during the cutting process. The rail 313 interfaces with the cutter rail interface 305 (e.g., a notch or groove into which rail 313 fits snuggly or snaps). The motor end cap 312 also has features (e.g., a groove) that interface with the rail 313 so that the cutter 301 and motor end cap 312 are perfectly aligned. This is critical to maintain clean/precise/safe cutting. In an embodiment, the rotational motor (e.g., the shade motor) is used to turn/roll fabric 309 during the cutting process, where blade 304 (at the position along the length of the roll dictated by cutter sled 307, which was set by measurement stick 203) cuts through turning fabric 309. In another embodiment, the roll of fabric 309 may be manually turned (by a user) during the cutting process. This embodiment may also be relevant in lower cost applications where a custom shade, but not a custom motorized shade, is used.

In one embodiment, the motor may be installed inside the roller tube. When the motor is activated, it rotates a shaft that is connected to the tube. This causes the tube to rotate as well, which in a hung shade allows the shade to raise and lower. In the cutting configuration shown here, the motor turns the fabric to achieve a fabric slitting function. Fabric slitting is used commonly in fabric production to shorten the width of a long roll of fabric. This technique is used, for example, with respect to toilet paper where ten feet wide rolls of toilet paper are fabric slit according to fabric slitting into thirty separate rolls of toilet paper. Fabric slitting is a conversion process in manufacturing that involves cutting large rolls of fabric into narrower rolls. Slitters are used in the textile industry for other purposes as well.

FIG. 3f illustrates the area of the fabric 309 that is cut during the custom sizing or cut-to-fit of the window treatment fabric. It is essential to use a fabric wrap 319 such as a tape or shrink wrap or other material to keep the fabric tightly wrapped and bound to prevent any fabric crawl during cutting. Wrapped area 318 is the wrapped area of fabric 309 used to prevent fabric creep while fabric 302 is being cut.

FIG. 3g illustrates the telescoping rod interface relative to the cutting system. It is critical that the blade 304 is able to cut completely through the fabric 309 and fabric core 319 in order for the fabric 309 and fabric core 319 to be removed from the telescoping rod after cutting is complete. This is achieved by ensuring the cut is done over the inner extrusion 315 of the telescoping rod interface where there is sufficient gap between the fabric core 319 and inner extrusion 315 to allow a clean cut. Fabric core 319 may be made of any suitable material that is cuttable using the same blade as fabric cutting blade 304, such as cardboard, an extruded plastic, or special type of rigid fabric. Inner extrusion 315 may be a sturdier material, such as a metal like aluminum or a strong plastic.

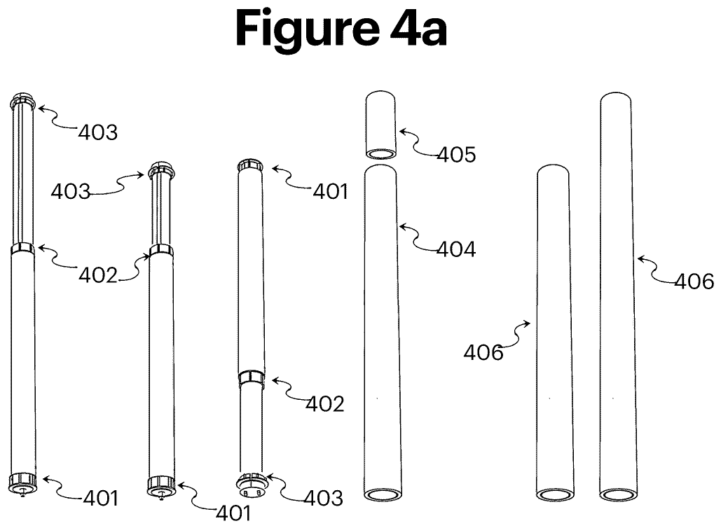

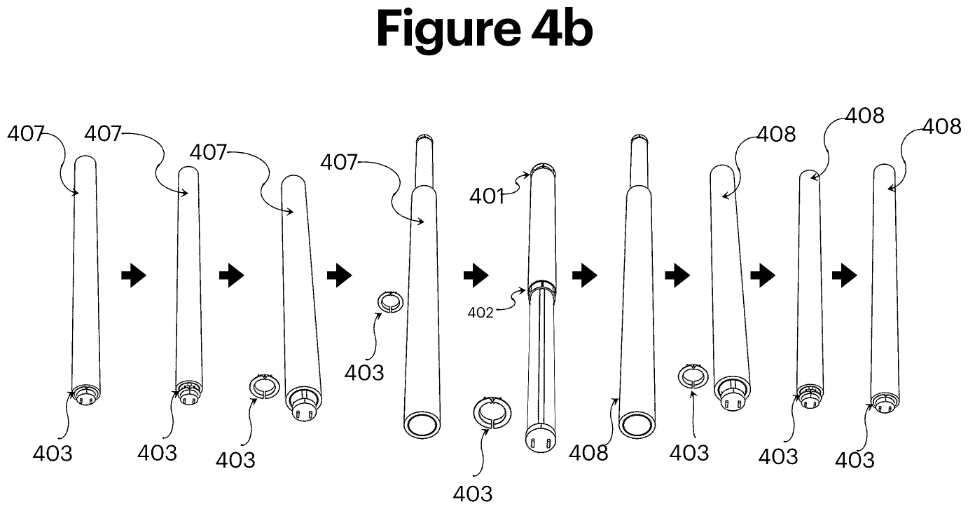

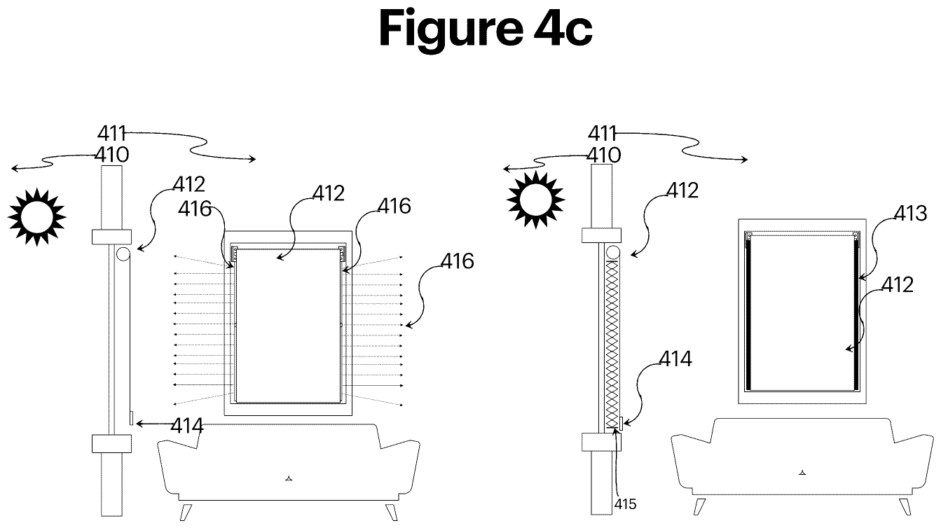

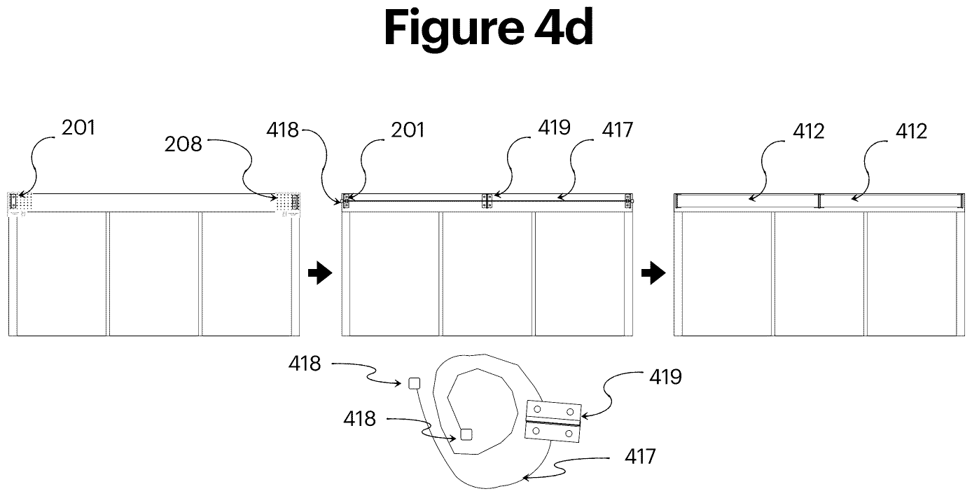

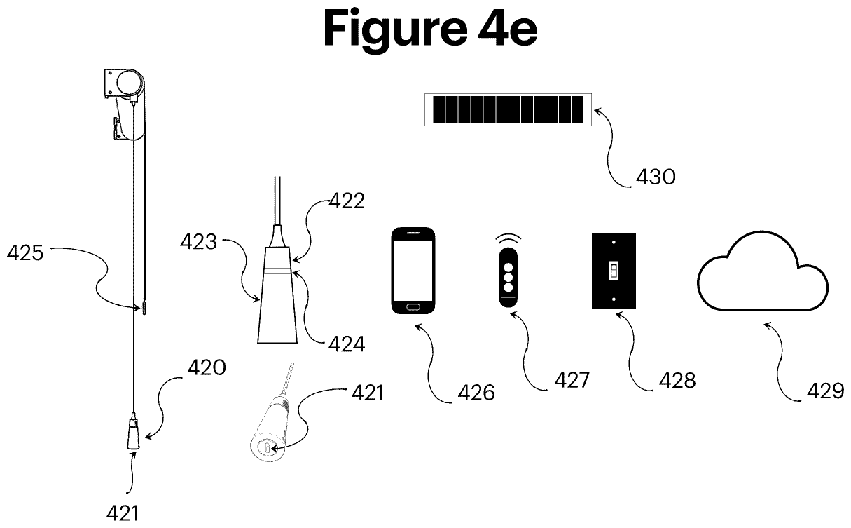

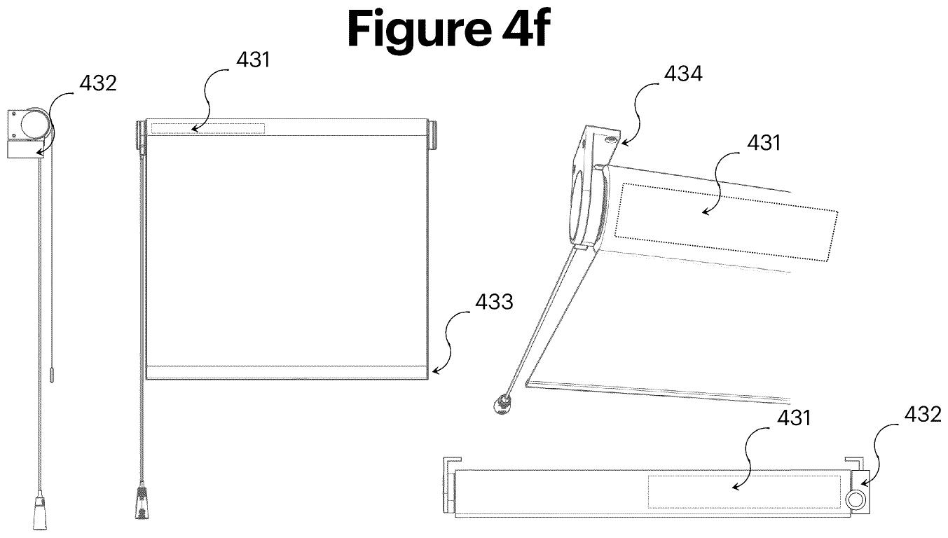

FIG. 4a illustrates the telescoping rod interface with fabric attach interfaces. In order to roll the window treatment up/down, the telescoping rod must have good friction/traction/torque with the fabric and fabric core. There are 3 points of contact used in this model. One is located at the end plug referred to as the end cap extension fabric interface 401, the other at the telescoping interface between inner and outer extrusion called the telescoping fabric interface 402 and the last one is at the motor side fabric interface 403.

The telescoping rod interface can be used with cut-to-fit fabrics (shown as the keep cut 404 and off cut 405 fabrics) or stretch-to-fit fabrics 406.

FIG. 4b illustrates the removal of an existing fabric 407 and attachment of a new fabric 408 which allows the changing of fabric on an adjustable telescoping rod. This removal is and replacement is facilitated by the removal of the motor side fabric interface 403.

FIG. 4c illustrates a bracket extension interface for light-bleed blackout blocker. Roller shades 412 are often considered the most design friendly type of window treatment and the roller rod is a simple mechanical system that is reliable and robust. However, when a roller shade 412 is inside mounted, there is some gap required on the left and right sides for brackets and motor where light can bleed in from the window 416 from the outside 410. For solar/privacy shades, this is not a problem. However, for blackout shades where total darkness is required, this can be a big problem and require using vertical rails to be installed on the window which is ugly and costly. Another approach is changing the mounting of the window treatment altogether to an outside mount which may not be desirable to the end user.

Cellular shades 413 on the other hand can achieve a very good fit edge to edge for blackout applications as there is no space required for brackets and motor on the right and left sides. The design shown here is a cellular shade 413 that has been cut to fit and mounted to the same bracket used for a roller shade 412. The cellular shade 413 can now be raised and lowered behind the roller shade 412 by connecting the roller shade bottom hem bar 414 and cellular roller shade bar 415. This can be done mechanically so that the shades can be raised and lowered together or separately. Utilizing only the motor in the roller shade 412, the cellular shade 413 requires no motor or complex system to raise and lower as it is coupled to the roller shade 412.

This has great advantages of cost, reliability and thermal properties.

FIG. 4d illustrates a bracket extension system for mounting two shades side by side easily. To enable this installation, the user can mount shade brackets 201 on the far left and far right of their window using the bracket template 208. Once the brackets 201 are mounted, the user connects one end of the bungee attach 418 to the far left bracket 201 and the other end of the bungee attach 418 to the far right bracket. The tension of the bungee cable holds the center bracket 419 in place and in center for the user to install.

FIG. 4e illustrates the multi-modal control and charging for this window covering system. The main method of control is physically attached to the shade via a cable. This is the pull chain control 420. The pull chain control 420 features two distinct pull zones: pull chain pull zone 1 422 and pull chain pull zone 2 423. These distinct pull zones allow the user to control a single shade or a group of shades with distinct actions. For instance pull chain zone 1 422 might raise/lower/stop the shade it is physically connected to while pull chain zone 2 423 might raise/lower/stop the all shades that are grouped with the shade it is physically connected to. Other modalities support pull chain zone 1 422 doing raise while pull chain zone 2 423 does lower. Additionally, the shade can be controlled by mobile device 426 or remote control 427 or wall switch control 428 or cloud control 429. The cloud control 429 can determine the schedule for controlling the shades based on zip code, day of year, time and shade orientation as well as embedded sensor information.

Multimodal charging refers to the ability to charge the shade using a variety of charging methods. There is a built-in power interface on the shade that allows connecting a charging source such to the pull chain charger 421 interface or directly to the shade such as solar charging 430. The pull chain charger 421 can be connected to a power bank or power supply or mobile phone for charging. The pull chain light 424 indicates the state of charge for the system. Furthermore, solar charging 430 can be mounted inside the window, outside the window or even attached to the bottom hem bar to charge sensor packs or lighting elements in the bottom hem bar.

FIG. 4f illustrates sensor packs and lighting options for the window covering system. Using the battery or power source of the shade, sensors can be added to the window covering system to add intelligent features. These sensor packs or lights can be integrated sensor pack 432 into the roller rod of the system or attached the bracket as an add-on sensor pack 431. Also, the hem bar provides another opportunity to add additional functionality. The illustration shows a sensor pack including motion, occupancy, temperature, humidity, light, acceleration, smoke, glass break, or air quality sensors that can be an add-on sensor pack 431 or integrated sensor pack 432 or in the lighted hem bar 433.

Lighting is also an important feature for indoor and security. Lighting can be integrated into the hem bar 433 or on bracket 434. Lighted hem bar 433 offers the unique ability to change the color of the fabric by light-piping different colors through a transparent or semi-transparent woven or non-woven material.

### III. Additional Embodiments

The above-described systems can be extended to any custom fabric system such as screen doors, window screens, window awnings or video projection screens.

In view of the foregoing description, it can be seen that the systems and methods described herein encompass at least the following:

An easy to install window treatment system with brackets that integrate adjustable measurement stick with ratchet, tensioning, integrated level, locking, attachment/removal or measurement viewfinder.

An adjustable measurement stick with ratchet, tensioning, integrated level, locking, attachment/removal or measurement viewfinder that can be used with a window treatment cutting system.

An adjustable measurement stick with ratchet, tensioning, integrated level, locking, attachment/removal or measurement viewfinder that can be used as a hem bar.

A window treatment bracket with measurement removal/attach interface or preloaded screw interface.

A window bracket template with casing alignment feature or edge alignment feature.

A manual cutting system for fabric that integrates measurement or safety features.

A spring force cutting system for fabric that integrates measurement or safety features.

A cutting system for cellular shade or blinds that integrates measurement or safety features.

An adjustable width cutting system for use in a shipping box or shipping tube.

A rail and sled system for motorized cutting.

A method for wrapping fabric to ensure clean cutting.

A telescoping rod interface and complete cutting system.

Telescoping rods with multiple fabric attach points.

Methods for replacing fabric on a telescoping rod.

Methods for adding a cellular shade blackout shade to a motorized roller shade for efficient and low cost blackout functionality to reduce light bleed.

A method for mounting a bracket extension for two side by side shades.

A pull chain controller for a shade with multiple pull zones and built in charging capabilities

An add-on or integrated sensor pack for motion, occupancy, temperature, humidity, light, acceleration, smoke, glass break, or air quality sensors that works with a shade system.

A cloud control that can determine the schedule for controlling the shades based on zip code, day of year, time, and shade orientation as well as embedded sensor information.

An add-on or integrated lighting solution for a shade system.

In further embodiments, a cut-to-size modular motorized window treatment system is configured in accordance with any of the embodiments described herein.

A cut-to-size modular motorized window treatment system is provided for any of a window shade, a screen door, a window screen, window awnings, or a video projection screen in accordance with any of the embodiments described herein.

An easy to install window treatment system includes brackets that integrate adjustable measurement stick with ratchet, tensioning, integrated level, locking, attachment/removal or measurement viewfinder in accordance with any of the embodiments described herein.

An adjustable measurement stick includes one or more of a ratchet, tensioning, integrated level, locking, and/or an attachment/removal or measurement viewfinder that can be used with a window treatment cutting system in accordance with any of the embodiments described herein.

An adjustable measurement stick includes one or more of a ratchet, tensioning, integrated level, locking, attachment/removal or measurement viewfinder that can be used as a hem bar in accordance with any of the embodiments described herein.

A window treatment bracket includes a measurement removal/attach interface or preloaded screw interface in accordance with any of the embodiments described herein.

A window bracket template includes a casing alignment feature or edge alignment feature in accordance with any of the embodiments described herein.

A manual cutting system for fabric integrates measurement or safety features in accordance with any of the embodiments described herein.

A spring force cutting system for fabric integrates measurement or safety features in accordance with any of the embodiments described herein.

A cutting system for cellular shade or blinds integrates measurement or safety features in accordance with any of the embodiments described herein.

An adjustable width cutting system is configured for use in a shipping box or shipping tube in accordance with any of the embodiments described herein.

A rail and sled system is configured for motorized cutting in accordance with any of the embodiments described herein.

A method for wrapping fabric is provided that ensures clean cutting in accordance with any of the embodiments described herein.

A telescoping rod interface and complete cutting system are configured in accordance with any of the embodiments described herein.

Telescoping rods with multiple fabric attach points are configured in accordance with any of the embodiments described herein.

Methods for replacing fabric on a telescoping rod are provided in accordance with any of the embodiments described herein.

Methods are provided for adding a cellular shade blackout shade to a motorized roller shade for efficient and low cost blackout functionality to reduce light bleed in accordance with any of the embodiments described herein.

A method is provided for mounting a bracket extension for two side by side shades in accordance with any of the embodiments described herein.

A pull chain controller for a shade is configured with multiple pull zones and built in charging capabilities in accordance with any of the embodiments described herein.

An add-on or integrated sensor pack is configured for motion, occupancy, temperature, humidity, light, acceleration, smoke, glass break, or air quality sensors that works with a shade system in accordance with any of the embodiments described herein.

A cloud control is configured to determine the schedule for controlling the shades based on zip code, day of year, time and shade orientation as well as embedded sensor information in accordance with any of the embodiments described herein.

An add-on or integrated lighting solution for a shade system is provided that is configured in accordance with any of the embodiments described herein.

### IV. Conclusion

While various embodiments have been described above, it should be understood that they have been presented by way of example only, and not limitation. It will be apparent to persons skilled in the relevant art(s) that various changes in form and details can be made therein without departing from the spirit and scope of the invention as defined in the appended claims. Thus, the breadth and scope of the present invention should not be limited by any of the above-described exemplary embodiments, but should be defined only in accordance with the following claims and their equivalents.

What is claimed is:

1. A window treatment system, comprising:
a collapsible measurement stick locked in a first expanded position to extend between and hold first and second brackets in positions with respect to a window, the measurement stick indicating a measurement of a length of expansion of the measurement stick in the expanded position.

2. The window treatment system of claim 1, wherein the measurement stick comprises:
a stick lock button configured to enable the measurement stick to be locked in a plurality of expanded positions including the first expanded position.

3. The window treatment system of claim 2, wherein the measurement stick comprises:
a viewfinder that provides the measurement of the length of expansion of the measurement stick in any of the plurality of expanded positions.

4. The window treatment system of claim 3, wherein the measurement stick comprises:
a stick removal/attach interface configured to enable
attachment of the measurement stick between the first and second brackets, and
removal of the measurement stick from between the first and second brackets, and
the viewfinder configured to maintain the measurement of the length of expansion of the measurement stick after the removal of the measurement stick.

5. The window treatment system of claim 3, wherein the first and second brackets are respectively positioned against opposing side jam extensions of a window, first and second locations on a window head casing, or first and second locations on a wall.

6. The window treatment system of claim 1, wherein the measurement stick comprises:
a stick level that provides a level indication corresponding to an orientation of the measurement stick.

7. The window treatment system of claim 1, wherein the measurement stick comprises:
at least one of a tension ratchet or a tension spring configured to maintain tension in the measurement stick.

8. The window treatment system of claim 1, further comprising:
a window treatment hung from the measurement stick.

9. The window treatment system of claim 1, wherein the first bracket includes at least one preloaded screw interface configured to hold a corresponding screw in position to be screwed into a surface to secure the first bracket to the surface, and to enable a surface to be marked at a location prior to the corresponding screw being screwed into the surface.

10. A roller cutter system, comprising:
a cutter housing configured to receive a roll of fabric rolled around a fabric core;
a cutting blade rotatably affixed to the cutter housing;
a rail system having a length along which the cutter housing is movable to a plurality of cut positions; and
a cutter lever rotatably affixed to the cutter housing and configured to rotate the cutting blade to penetrate the roll of fabric and cut the roll of fabric through the fabric core at a current cut position of the cutter housing along the length of the rail system.

11. The roller cutter system of claim 10, further comprising:
a cutter safety configured to receive a measurement stick, the cutter safety configured to lock the cutting blade when the measurement stick is not received and to unlock the cutting blade when the measurement stick is received.

12. The roller cutter system of claim 11, wherein the measurement stick is locked at a length of expansion used to define the cut position.

13. The roller cutter system of claim 11, wherein the cutter safety is further configured to lock the cutting blade when the roll of fabric is not received by the cutter housing.

14. The roller cutter system of claim 10, further comprising:
a spring configured to force the cutting blade to rotate into penetrating the roll of fabric.

15. The roller cutter system of claim 10, further comprising:
a cutter lever configured to receive manual force to rotate the cutting blade to penetrate the roll of fabric.

16. The roller cutter system of claim 10, further comprising:
a motor configured to rotate the roll of fabric.

17. The roller cutter system of claim 16, further comprising:
a shipping box that contains the cutter housing, the roll of fabric, the cutting blade, the rail system, the cutter lever, and the motor, the roller cutter system operational to cut the roll of fabric inside the shipping box.

18. A method for a window treatment, comprising:
locking a collapsible measurement stick in a first expanded position to extend between and hold first and second brackets in positions with respect to a window, the measurement stick indicating a measurement of a length of expansion of the measurement stick in the expanded position;
mounting the first and second brackets in the positions;
detaching the measurement stick from the mounted first and second brackets;
inserting the measurement stick in a roller cutter system that contains a roll of fabric;
sliding a cutter housing along a rail system of the roller cutter system to a position matching the length of the locked measurement stick, when the locked measurement stick is engaged between the cutter housing and an endcap, the measurement stick unlocks the cutting blade;
rotating a cutting blade of the cutter housing to penetrate the roll of fabric at the position;
turning the roll of fabric to cut the roll of fabric by the cutting blade to a shorter length roll of fabric; and
removing the shorter length roll of fabric from the roller cutter system.

19. The method of claim 18, further comprising:
installing the shorter length roll of fabric between the first and second brackets as a first window shade for the window.

20. The method of claim 19, further comprising:
installing a roll of fabric for a cellular shade between the first and second brackets in parallel with the shorter length roll of fabric of the first window shade; and
connecting a roller shade bottom hem bar of the first window shade and a cellular roller shade bar of the cellular shade to enable raising and lowering of the cellular shade with the first window shade by a motor of the first window shade.
